(19) United States
(12) Patent Application Publication
(10) Pub. No.: US 2009/0084321 A1
(43) Pub. Date: Apr. 2, 2009

(54) TOILET FLUSHABLE TYPE BIODEGRADABLE COLLECTION BAG

(75) Inventor: Xiongxun Mo, Jiangmen City (CN)

Correspondence Address: HANLEY, FLIGHT & ZIMMERMAN, LLC, 150 S. WACKER DRIVE, SUITE 2100, CHICAGO, IL, 60606, US

(73) Assignee: Jiangmen Proudly Water-soluble Plastic Co., Ltd., Jiangmen City (CN)

(21) Appl. No.: 12/022,810

(22) Filed: Jan. 30, 2008

(30) Foreign Application Priority Data
Sep. 30, 2007 (CN) 200710175550.7

(51) Int. Cl. A01K 29/00; B65D 30/02

(52) U.S. Cl. 119/161; 383/1

(57) ABSTRACT

The description includes a toilet-flushable type biodegradable collection bag, more specifically, a toilet-flushable type biodegradable collection bag which has certain water-resistance but can soften or disintegrate rapidly when flushed with a fast and large water flow. The toilet-flushable type biodegradable collection bag according to the examples herein may be manufactured from the film prepared from the raw materials comprising a polyvinyl alcohol resin, a filling agent, a natural polymer material, a plasticizer, and the like. The toilet-flushable type biodegradable collection bag according to the examples combines the water-resistance and the toilet-flushable property of the film, and has an advantage of water-resistance to a degree while satisfying the toilet-flushable property and biodegradability. The collection bag can be used to collect waste with certain water content, such as excrement and vomit of people or pet waste without dissolution or break. Once the collection bag contacts plenty of water when discarded into a toilet, the collection bag softens or disintegrates rapidly, and then it is flushed into the sewer successfully and biodegraded completely in the septic tank.

### TECHNICAL FIELD

The present disclosure relates to biodegradable collection bags and, more specifically, to a toilet-flushable type biodegradable collection bag. Such a collection bag has a certain water-resistance, but softens or disintegrates rapidly when flushed with a fast moving and large water flow.

### BACKGROUND

In current society, as a result of the increasing number of pets, numerous environmental problems have been brought about by the disposal of pet waste. There exists in pet waste many kinds of pathogenic bacteria such as tubercle bacillus, brucellosis, and salmonella. If the pet waste is left exposed in the nature, it will not only affect environmental sanitation, but also allow the pathogenic bacteria thereof to spread in the air or enter into the groundwater or river to contaminate the water resource. It is considered that the pet waste has become a serious pollutant source. Therefore, many countries have stipulated that pet owners must collect and dispose of the waste of their pets.

At present, pet-owners can only collect pet waste and discard it as household garbage. In order to easily collect and carry pet waste, a collection bag is prepared with a common plastic film such as polyethene (PE) film because pet waste contains water. The merit of this PE collection bag is that it is resistant to water penetration when carried, has certain strength, and the price is also cheap. However, the common films, such as PE film, are all polymer materials that do not degrade when expose to nature (i.e., they are not biodegradable). Using such PE films extensively will result in the following problems: 1) the film of the collection bag possesses no biodegradability and toilet-flushable property, so it can only be discarded as the household garbage after use, which will produce vast quantities of nondegradable garbage; 2) discarding or disposing the pet waste, which contains numerous pathogenic bacteria, in the same manner as the household garbage tends to spread the pathogenic bacteria in the air, and do harm to the health of persons such as sanitation workers; 3) it increases the difficulty and cost of waste sorting, disposal, and recycling; 4) when the waste is disposed by way of burying, the pet waste containing plenty of pathogenic bacteria is liable to spread the pathogenic bacteria into the groundwater or river to pollute the water resource during the course of burying.

There exist the aforementioned problems not only in the disposal and collection of the pet waste, but also in the collection of other types of human or pet excrement such as vomit.

Biodegradable, water-soluble collection bags can be provided for the above-mentioned users, but when these collection bags are used to collect waste with certain water content, it is not certain that they will not break after containing this waste if these collection bags do not possess better water-resistance and strength. Additionally, the collection bags with certain water-resistance and strength should be able to soften or disintegrate rapidly when flushed down a toilet having a fast and large water flow, or in a condition of plenty of water. The water-resistance and toilet-flushable property of the collection bag are paradoxes. The collection bag only in consideration of its toilet-flushable property or biodegradability or the water-resistance does not facilitate their uses in these special situations.

Many investigations of film material with biodegradability as well as water-solubility have been done, but the topic attracting more attention is still the water-solubility of this material. The typical one among these materials is polyvinyl alcohol (PVA) film. One of the important characteristics of this film material is good water-solubility and biodegradability. Accordingly, how to increase its dissolving speed by improving the composition and process technology becomes a key concern. For example, Chinese patent application No. 02826192.5 describes “a polyvinyl alcohol based film.” In order for the PVA film to achieve the aim of good solubility in cold water, it is proposed to use two kinds of PVA resin material with different saponification degrees, wherein the low saponification degree resin has a saponification degree of 55 mol % to 80 mol %, and the high saponification degree resin has a saponification degree of 88 mol % to 99.99 mol %. The PVA film according to this prior patent application is mainly suitable for the cell-package of the medicaments such as pesticide or lotion, wherein the medicament and the package are thrown into water together when used and then the film will dissolve rapidly in water at normal temperature to release the medicament over time and also dissolve completely so as not to interfere with the normal use of the medicament.

Chinese patent No. 02113921.0 makes public “a method for regulating the water-dissolving speed of the water-soluble film.” This patent describes that the regulation of the water-dissolving speed of the film can be realized through adjusting the proportions of the partly alcoholyzed PVA, the completely alcoholyzed PVA, and starch. In particular, the water-dissolving speed can be increased through adding starch into the film forming agent. But to achieve a desired dissolving speed, the proportions of the raw materials need to be further confirmed according to the demand of the user. Furthermore, the object of this Chinese patent is still the water-solubility of the film.

Therefore, all the PVA films disclosed nowadays cannot satisfy the demand that it can be used to collect and dispose some waste with certain water content and then can be discarded into the common toilet for disposal, especially the demand of collecting such waste as pet waste.

### BRIEF DESCRIPTION OF THE DRAWINGS

FIG. 1 shows a schematic view of an example of a monolayer bag of the toilet-flushable type biodegradable collection bag described herein. In one example, the planar size is 270 mm×200 mm.

FIG. 2 shows a schematic view of an example of a double layer bag of the toilet-flushable type biodegradable collection bag described herein.

FIG. 3 shows a schematic view illustrating an example process of collecting pet waste using the toilet-flushable type biodegradable collection bag described herein.

### DETAILED DESCRIPTION

Described herein is a toilet-flushable type biodegradable collection bag, which further has an advantage of water-resistance to a certain degree while satisfying toilet-flushable property and biodegradability. The collection bag can be used to collect the waste with certain water content such as excrement or vomit of a person or pet without dissolution or break. Once the collection bag contacts plenty of water when discarded into a toilet, it will soften or disintegrate rapidly, and then be flushed into the sewer successfully and biodegraded completely in the septic tank.

According to one example, a toilet-flushable type biodegradable collection bag may be prepared from polyvinyl alcohol (PVA) film and at least the film of the bag body portion for contacting the waste is the first film, said first film has a thickness of approximately 15 to 100 micrometers (μm) and is manufactured by a film-composition comprising:

10 wt. %-90 wt. % of polyvinyl alcohol resin raw material

0-20 wt. % of filling agents

0-50 wt. % of natural macromolecule material

8 wt. %-50 wt. % of plasticizer

Wherein the polyvinyl alcohol resin raw material may be consist of a low alcoholysis degree polyvinyl alcohol resin having an alcoholysis degree of approximately 80 to 93 mol % and a high alcoholysis degree polyvinyl alcohol resin having an alcoholysis degree of 93.1 to 99.99 mol %, and the ratio of the low alcoholysis degree polyvinyl alcohol resin to the high alcoholysis degree polyvinyl alcohol resin is from 90:10 to 0:100 (w/w).

In addition to the special illuminate, all the percentage in this invention is on the basis of weight.

The raw materials for film of the example bag body, especially the materials for the first film used to contact with the waste, are selected and combined properly so that the film with such specific composition is water-resistant to a certain extent. According to one example, the film will not dissolve when contacting with a substance, such as waste, containing little water at a normal temperature; it will, however, soften or disintegrate when contacting with plenty of water. When the toilet-flushable type biodegradable collection bag as described herein is used to collect the waste with certain water content, the bag body will not dissolve or break; and it will soften or disintegrate rapidly when contacting with a fast and large water flow, or when immersed in plenty of water.

There is a certain difference in the water-solubility of the polyvinyl alcohols with different alcoholysis degrees, and the essence described herein is to consider and make use of this difference fully to obtain a film with better water-resistance than that of the polyvinyl alcohol film with high dissolving speed in water, so as to unify the two incompatible characteristics of water-solubility and water-resistance, effectively. It should be understood that the first film with relatively good water-resistance described herein is just relative to the common PVA film, which is merely characterized by the water-solubility.

The biodegradable collection bag described herein can be a series of products prepared with PVA resin materials of different types or specifications. The characteristics of water-resistance and water-solubility can be so regulated via changing the composition and thickness of the film within the above-mentioned range so as to meet a certain requirement for use and be used for different collections and in different situations.

There always exists certain water content in waste, such as excrement or vomit of a person or a pet, and water-resistant bag body is often used for collecting the same in view of sanitation and convenience. The film material according to the examples provided herein is a material combining the water-resistance and water-solubility together as mentioned above and the formulation thereof is developed by the inventor through investigating and testing thoroughly and repeatedly. This film material can ensure the collection bag prepared with it against break when contacting with a little substance (e.g., waste) having water content during the course of collecting the waste. As a result of contacting with plenty of water when the bag is discarded into a common toilet, this collection bag for waste will soften or disintegrate in a short time so that the collection bag is easily flushed away by a water flow without jamming the sewer. The softened or disintegrated collection bag (film) enters into the septic tank together with the waste and after a duration of time it will degrade naturally into carbon dioxide and water, ultimately. As such, neither the collection bags or the waste will do harm to the environment and the health of human beings. So the example bags described herein are referred to as “the toilet-flushable type biodegradable collection bag.”

In the collection bag described herein, at least a first film material of the bag body used to contact with the collection has a thickness of about 15 μm to 100 μm, and, in one particular example, between 20 μm to 70 μm. The thicker the film material is, the better the strength and water-resistance of the film material is, and the higher the bearing capability of the collection bag to the water content of the waste is, and the time for the collection bag to soften or disintegrate when contacting with water is prolonged and the preparative cost of the collection bag is increased as well. Therefore, the collection bag described herein can be the product of different specifications according to the demand of the user in which the thickness may be limited within the above-mentioned range.

According to the present description, the polyvinyl alcohol resin raw material with alcoholysis degree in certain range, especially a mixture of polyvinyl alcohol resins with different alcoholysis degrees, can be used as the raw material for the above-mentioned first film with better water-resistance. The above-mentioned polyvinyl alcohol resin raw material should have certain polymerization degree so that the collection bag prepared can satisfy the demands of water-resistance, the ability to be flushed away in the toilet, and mechanical strength at the same time. In one example, the polyvinyl alcohol resin raw material having a polymerization degree of approximately 300 to 3500 may be used. If the polymerization degree is too low, the mechanical strength of the film is insufficient; and if the polymerization degree is too high, it is difficult for processing. In another example, the polyvinyl alcohol resin raw material having a polymerization degree of approximately 1000 to 2500 may be used.

In the raw material (A) of PVA based resins with different alcoholysis degrees, the PVA resin having an alcoholysis degree of about 80 mol % to 93 mol %, preferably the PVA resin having an alcoholysis degree of about 86 mol % to 93 mol %, is selected as the low alcoholysis degree resin (a1); the PVA resin having an alcoholysis degree of about 93.1 mol % to 99.99 mol % is preferably selected as the high alcoholysis degree resin (a2). In the examples, each of the resins in two different alcoholysis degree ranges (a1 and a2) can comprise one resin or a combination of more thereof. The ratio between them can be adjusted properly according to the purpose and condition used of the collection bag. The ratio of a1/a2 is about 90/10 to 0/100 (weight/weight), in some examples about 75/25 to 0/100 (weight/weight), and in other examples about 75/25 to 15/85 (weight/weight). When the low alcoholysis degree polyvinyl alcohol and/or the high alcoholysis degree polyvinyl alcohol are/is the combination(s) of polyvinyl alcohols of two or more specifications, the above-mentioned ratio refers to the ratio of their total weight. As the higher the content ratio of the PVA based resin (a2) with high alcoholysis degree is, the better the water-resistance of the film material is, the higher the bearing capability of the collection bag to the water content of the collection is, and the longer the time for the collection bag to soften or disintegrate when contacting with water is.

The content of PVA resin raw material (A) can be adjusted according to the environments of application, tensile strength, and production cost. Decreasing the content of PVA resin (A) is beneficial to reduce the cost, but the tensile strength of the film will be decrease, accordingly. Preferably, the content of PVA resin (A) in the film-composition used for manufacturing the first film is approximately 20 wt. %-80 wt. %.

The same as the general process technology for the film, the components of the PVA film used to prepare the example collection bag described herein, especially the first film for contacting with the collection, further comprise a general filling agent (B), a natural polymer material (C) and a plasticizer (D).

Addition of the filling agent (B) can improve the processability of the film and reduce the stickiness and transparence of the PVA based film. The filling agent used can be a general filling agent in the film process, for example, one or more selected from the group consisting of olefin, Polyethylene wax, silicon dioxide, talcum powder, calcium carbonate, magnesium carbonate, magnesium hydroxide, calcium stearate, titanium dioxide, lithopone, magnesium stearate, Octadecanamide, and stearic acid. The content of the filling agent is confirmed through considering all things of the anti-stickiness of the film, the processability and transparence of the film, i.e., if the content of the filling agent (B) is too low, it is helpless to the transparence and anti-stickiness of the film and the improvement of the processability of the film; if the content of the filling agent (B) is too high, the tensile-strength of the film is reduced and the process becomes difficult. In some examples, the preferred content of the filling agent (B) in the film-composition used for manufacturing to prepare the first film is approximately 2 wt. %-15 wt. %.

Furthermore, in order to prevent the caking of the material and reduce the productive cost, according to one example the natural polymer material (C) is added to the PVA based resin raw material in this invention, for example, one or more selected from the group consisting of cellulose, xylogen, starch, chitin, chitosan and polysaccharide modifier (e.g., amorphophallus konjac). The addition of this material is helpful for reducing production costs, but if the content is in the film-composition used for manufacturing the first film higher than approximately 50 wt. %, the anti-tensile strength is reduced remarkably. The preferred content of natural polymer material (C) in the film-composition used for manufacturing the first film is approximately 0-45 wt. %.

The plasticizer used for this film process can be a plasticizer commonly used for PVA based film, for example, one or more selected from the group consisting of glycerol, digylcerol, polyethylene glycol, polypropylene glycol, caprolactam, trimethylolpropane, water and sorbitol, preferably glycerol, water, or sorbitol. When the content of the plasticizer (D) in the film-composition used for manufacturing the first film is less than about 8 wt. %, it is difficult to achieve the plasticization effect; when the content of the plasticizer (D) in the film-composition used for manufacturing the first film is more than about 50 wt. %, the plasticizer is liable to exude gradually from the surface of the film over time. In one example, the preferred content of the plasticizer (D) in the film-composition used for manufacturing the first film is roughly 16 wt. %-40 wt. %.

The PVA film is a water-soluble material itself, so the main concern is not the low temperature solubility and the dissolving speed of PVA film, but is to combine the water-resistance and water-solubility of the film. According to the examples described herein, it is hoped that this film is not readily soluble in water at a normal temperature, and especially hoped that this film can keep the original strength and better water-resistance (i.e., it will not dissolve and break) when contacting with a little water, but can soften and disintegrate rapidly when contacting with plenty of water (namely toilet-flushable property). The collection bag prepared with this film is suitable for collecting the substance with a little water and particularly, for example, waste such as pet waste, the excrement of the incontinent sufferers, and vomit.

By investigation and determination of the composition of the film with better water-resistance, the example collection bag has three notable characteristics besides the biodegradability and toilet-flushable property as follows: 1) the collection bag can keep insoluble and unbreakable when containing the substance with a little water; 2) it can soften or disintegrate rapidly when contacting with or immersed in plenty of water, which is helpful for the user to discard it into a toilet and then flush it into the septic tank successfully through the sewer; 3) it has biodegradability and can eliminate the environmental pollution problem completely.

For the toilet-flushable type biodegradable collection bag provided described in the examples herein, according to the demand, the bag body may have a structure of double layer film in which one layer is the polyvinyl alcohol film layer having better water-resistance used to contact with the collection (e.g., waste) and the other layer is a general polyvinyl alcohol film having better water-solubility. That is to say, the double layer bag body is prepared from the general polyvinyl alcohol film having water-solubility and the above-mentioned film having better water-resistance. After the waste is collected, the above-mentioned film having better water-resistance contacts the waste as the inner layer of the bag and the general PVA film with better water-solubility acts as the outer layer of the bag. Thus, the inner layer prevents the water in the waste from penetration and the outer layer is helpful for the whole bag body to soften or disintegrate rapidly when contacting with plenty of water in a toilet as it is flushed away.

The toilet-flushable type biodegradable collection bag described herein can also have a structure of monolayer film prepared with the film having better water-resistance. The content of each component is so controlled within the range of the above-mentioned formulation so that the bag body can satisfy water-resistance needs, possesses the desired softening property when contacting water, and maintains strength during use.

According to the examples described herein, by using appropriate process technology, one side of the bag body contacting with the collection (e.g., waste) is coarse and has a hydrophobic effect, and the water-resistance thereof is better than that of the slippery side. The other side of the bag body is slippery and can easily dissolve in water and soften. In the case of collecting the pet waste, the coarse side is employed to contact with the pet waste with certain water content so that the collection bag will not dissolve or break; when the collection bag with waste is discarded into a toilet to be flushed away, the slippery side of the film softens or disintegrates rapidly as soon as it contacts plenty of water so that it can be flushed away without jamming the sewer.

According to the actual situation in use, the example collection bag is designed such that the film or layer used to contact with waste is the outer layer. That is to say, for the double layer bag, the above-mentioned film with better water-resistance is the outer layer (it can be merely set in the lower part of the bag which contacts with the waste), and the general polyvinyl alcohol film with better water-solubility is the inner layer; for the monolayer bag, the outer face is coarse and the inner face is slippery. In use, for example when collecting pet waste, stretch a hand into the bag firstly; then overturn the bag body after the waste is collected into the bag; discard the bag body directly into a toilet to flush it away. Of course, the design mode of the collection bag is not critical, for example, a reverse process can be used, i.e. the film or face used to contact with the waste is the inner layer or face; and in use, overturn the bag body firstly and then operate in the same way.

The collection bag as described in the examples herein can be prepared with any method, for example, using the well-known film forming method such as casting molding method (wet, dry), melt extrusion molding method (blowing, casting) and coating method to prepare the film, and then manufacturing it into the desired bag body. For the double layer bag described herein, any known method can be used for combining the PVA film with water-resistance (the first film) and the general water-soluble film (referred to as the second film in this invention) to prepare it. Wherein, the first film is the layer contacting with the collection in the double layer bag; the second film is the other layer of the double layer bag. Alternatively, two first films with different water-solubilities can be used for the double-layer bag.

The example collection bag described herein has biodegradability, and does not dissolve or break when contacting with a little water, but will soften or disintegrate rapidly when contacting with or immersed in plenty of water. It is a suitable collection bag for pet waste, and is convenient for use and can remind the pet owner to protect the environment. The collection bag described herein can also be used for nursing the incontinent or vomiting patients so as to simplify the operation during the practice of a nurse or other medical professionals.

In the following description, reference numerals 1, 2, and 10 refer to an outer layer, an inner layer, and a collection bag, respectively.

Hereinafter, the mode and beneficial effects are described herein with reference to examples. These examples, however, are intended to provide better understanding of the spirit of the invention, and it should be understood that the scope of the invention is not restricted thereto.

According to one example, a method of preparing a toilet-flushable type biodegradable collection bag includes the following:

1: The PVA-type resin raw material (A), filling agent (B), natural polymer material (C), and plasticizer (D) in amounts as shown in the formulation were added into a mixer and then mixed under stirring below approximately 100° C. for roughly 15 to 90 minutes. Thus a mixture material was obtained.

2: The mixture material prepared in 1 was added into a single-screw extruder or twin-screw extruder to granulate. The temperature ranges from the feed opening to the outlet were restricted approximately to 95 to 150° C., 150 to 250° C., 150 to 250° C., 150 to 250° C., and 150 to 200° C., sequentially.

3: The mixture material prepared in 1 or the granule material prepared in 2 was added into a single-screw extruder or twin-screw extruder to blow mold to films in the temperature range of roughly 150 to 250° C. The temperature ranges from the feed opening to the outlet were restricted to about 90 to 150° C., 150 to 250° C., 150 to 250° C., 150 to 250° C., and 150 to 250° C., sequentially.

4: The film prepared by blow molding in 3 was processed into mono layer bags or double layer bags by combining with a normal water-soluble film.

The two faces of the film prepared by blow molding according to the above-mentioned method are different obviously. One face is slippery and the other side is visibly rough.

The PVA resins used in the following examples includes: N-300 (the degree of alcoholysis is about 98.0 to 99.0 mol %; the degree of polymerization is about 1500 to 2000), C-500 (the degree of alcoholysis is roughly 94.0 to 96.0 mol %; the degree of polymerization is approximately 1500 to 2000), GM-14 (the alcoholysis degree is around 86.5 to 89.0 mol %; the degree of polymerization is about 1500 to 2000) from GOHSENOL series products manufactured by Japanese NIPPON GOHSEI corp.; JL-18E manufactured by JAPAN VAM & POVAL corp. (the degree of alcoholysis is about 83.0 to 86.0 mol %; the degree of polymerization is roughly 1500 to 2000); 2092 manufactured by Sinopec Sichuan Vinylon Factory (the degree of alcoholysis is roughly 91.0 to 93.0 mol %; the degree of polymerization is roughly 2000 to 2500).

In all of the examples, the amount of material is represented by percentage by weight on the basis of the film-composition, and the first film is prepared to manufacture the collection bag according to the above-mentioned method. All of the first films prepared according to the compositions of the raw materials in the following examples can be used as the bag body of the double layer collection bag contacting with the collection, or can be used directly to manufacture the collection bag with a monolayer structure. The evaluation for the water-solubility and water-resistance in some examples are all the relative properties based on the properties of the water-solubility and water-resistance being satisfied at the same time by the film used to prepare the example collection bag described herein.

### EXAMPLE 1

the PVA film having a thickness of about 30 μm and relative water-solubility (toilet-flushable property).

Materials: in approximate measure 74 wt. % PVA resin (wherein the ratio of JL-18E/C-500 is 90/10, w/w), 0.7 wt. % calcium stearate, 11 wt. % talcum powder, 11 wt. % glycerol, 3.3 wt. % water.

### EXAMPLE 2

the PVA film having a thickness of about 30 μm and relative water-solubility.

Materials: in approximate measure 18 wt. % PVA resin (wherein the ratio of JL-18E/C-500 is 90/10, w/w), 42 wt. % starch, 1 wt. % calcium carbonate, 21 wt. % glycerol, 12 wt. % sorbitol and 6 wt. % water.

### EXAMPLE 3

the PVA film having a thickness of about 30 μm and relative water-solubility.

Materials: in approximate measure 43 wt. % PVA resin (wherein the ratio of GM-14/C-500 is 75/25, w/w), 23 wt. % starch, 1.3 wt. % calcium carbonate, 16.4 wt. % glycerol, 10 wt. % sorbitol and 6.3 wt. % water.

### EXAMPLE 4

the PVA film having a thickness of about 20 μm and relative water-solubility.

Materials: in approximate measure 63 wt. % PVA resin (wherein the ratio of GM-14/C-500 is 65/35, w/w), 7 wt. % starch, 1.4 wt. % calcium carbonate, 14.8 wt. % glycerol, 6.8 wt. % sorbitol and 7 wt. % water.

### EXAMPLE 5

the PVA film having a thickness of about 50 μm.

Materials: in approximate measure 65 wt. % PVA resin (wherein the ratio of 2092/N-300 is 90/10, w/w), 4 wt. % lithopone, 5 wt. % talcum power, 16 wt. % glycerol, 3 wt. % sorbitol and 7 wt. % water.

### EXAMPLE 6

the PVA film having a thickness of roughly 50 μm.

Materials: in approximate measure 70 wt. % PVA resin (wherein the ratio of GM-14/N-300 is 55/45, w/w), 2 wt. % lithopone, 17.5 wt. % glycerol, 3.5 wt. % sorbitol and 7 wt. % water.

### EXAMPLE 7

the PVA film having a thickness of about 50 μm.

Materials: in approximate measure 70 wt. % PVA resin (wherein the ratio of GM-14/N-300 is 45/55, w/w), 2 wt. % lithopone, 14 wt. % glycerol, 7 wt. % sorbitol and 7 wt. % water.

### EXAMPLE 8

the PVA film having a thickness of approximately 50 μm.

Materials: in approximate measure 69 wt. % PVA resin (wherein the ratio by weight of GM-14/N-300 is 35/65, w/w), 2.8 wt. % magnesium hydroxide, 17 wt. % glycerol, 7 wt. % sorbitol and 4.2 wt. % water.

### EXAMPLE 9

the PVA film having a thickness of about 50 μm and relative water-resistance.

Materials: in approximate measure 69 wt. % PVA resin (C-500), 2.8 wt. % talcum power, 17 wt. % glycerol, 7 wt. % sorbitol and 4.2 wt. % water.

### EXAMPLE 10

the PVA film having a thickness of about 45 μm and relative water-resistance.

Materials: in approximate measure 69 wt. % PVA resin (wherein the ratio of GM-14/N-300 is 25/75, w/w), 2.8 wt. % talcum power, 17 wt. % glycerol, 7 wt. % sorbitol and 4.2 wt. % water.

### EXAMPLE 11

the PVA film having a thickness of roughly 45 μm and relative water-resistance.

Materials: in approximate measure 68 wt. % PVA resin (wherein the ratio of GM-14/N-300 is 15/85, w/w), 1.4 wt. % titanium dioxide, 20 wt. % glycerol, 3.6 wt. % sorbitol and 7 wt. % water.

### EXAMPLE 12

the PVA film having a thickness of roughly 45 μm and relative water-resistance.

Materials: in approximate measure 68 wt. % PVA resin (wherein the ratio of GM-14/N-300 is 5/95, w/w), 1.4 wt. % titanium dioxide, 20 wt. % glycerol, 3.6 wt. % sorbitol and 7 wt. % water.

### EXAMPLE 13

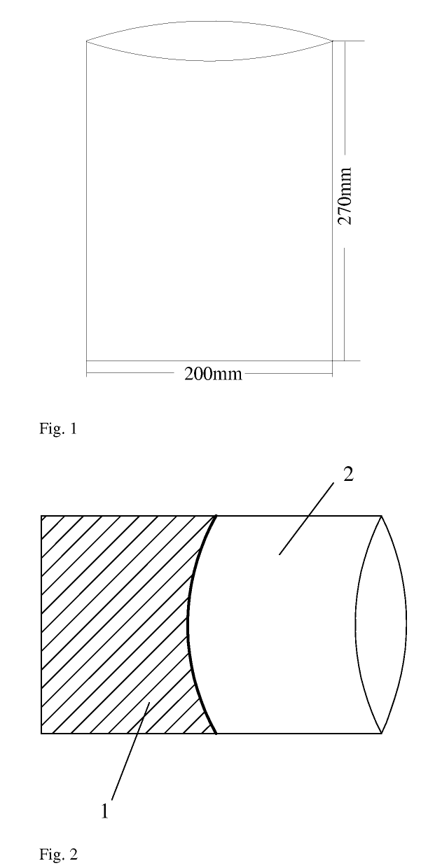

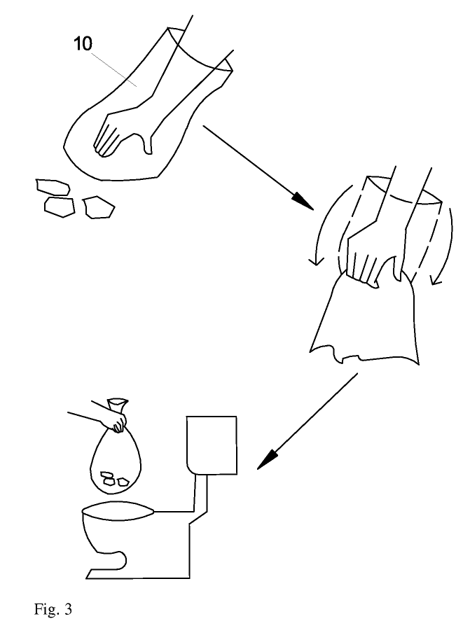

The polyvinyl alcohol film with better water-resistance is prepared according to the formulation and method in example 10. The polyvinyl alcohol film with better water-solubility is prepared according to the formulation and method in example 3. Then these two films are used to prepare the double layer bag. As shown in FIG. 2, the outer layer 1 of this double-layer bag is the first film with better water-resistance, the inner layer 2 is the polyvinyl alcohol film with better water-solubility relative to the outer layer, and the size of the outer layer film is smaller than that of the inner layer film.

The general polyvinyl alcohol film with better water-solubility can also be used as the inner layer of the collection bag.

The Toilet-Flushable Property Test of the Example Toilet-Flushable Type Biodegradable Collection Bag

To testify the toilet-flushable property of the example toilet-flushable type biodegradable collection bag described herein, the polyvinyl alcohol film prepared according to the formulation and method in example 6 is selected and prepared into the toilet-flushable type monolayer collection bag for pet waste. This collection bag is shown in FIG. 1. The details of the test are given as follows:

### TEST EXAMPLE 1

The collection bag with a size of 200 millimeters (mm)×270 mm×40 μm was immersed into an amount of water at 28° C. In 15 seconds, the bag began to become soft and slippery.

### TEST EXAMPLE 2

The collection bag with a size of 200 mm×270 mm×40 μm was immersed into an amount of water at 28° C. and the water is stirred continuously. In 15 seconds, the bag began to become soft and slippery; after 5 min, the bag began to break and disperse.

The Water-Resistance Test of the Example Toilet-Flushable Type Biodegradable Collection Bag

To testify the water-resistance of the example toilet-flushable type biodegradable collection bag described herein, the polyvinyl alcohol film prepared according to the formulation and method in example 10 is selected and prepared into the toilet-flushable type monolayer collection bag for pet waste. The details of the test are given as follows:

### TEST EXAMPLE 1

Test condition: under normal temperature and normal pressure

Test materials: water absorbing article (paper towel) 40 g, water at 40° C. 60 g and one toilet-flushable type biodegradable collection bag with a size of 200 mm×270 mm×45 μm.

The above-mentioned water absorbing article (paper towel) 40 g was soaked homogeneously with 60 g water at 40° C. to produce a wet article having a water content of 60% and a total weight of 100 g. One toilet-flushable type biodegradable collection bag with a size of 200 mm×270 mm×45 μm was used to pack this wet article and then hung for observation.

Test result: In 5 seconds, wrinkles appeared on the surface of the bag contacting with the wet article but no break; after 5 min, the bag had wrinkles and slight deformation but no break; after 2 hours, the bag had slight deformation but no break; after 2 days, the bag had wrinkles, slight deformation but no break.

### TEST EXAMPLE 2

Test condition: under normal temperature and normal pressure

Test materials: water absorbing article (paper towel) 30 g, water at 40° C. 70 g and one toilet-flushable type biodegradable collection bag with a size of 200 mm×270 mm×45 μm.

The above-mentioned water absorbing article (paper towel) 30 g was soaked homogeneously with 70 g water at 40° C. to produce a wet article having a water content of 70% and a total weight of 100 g. One toilet-flushable type biodegradable collection bag with a size of 200 mm×270 mm×45 μm was used to pack this wet article and then hung for observation.

Test result: In 5 seconds, wrinkles appeared on the surface of the bag contacting with the wet article but no break; after 5 min, the bag had wrinkles and obvious deformation but no break; after 2 hours, the bag had obvious wrinkles and obvious deformation but no break; after 2 days, the bag still had obvious wrinkles and obvious deformation but no break.

### TEST EXAMPLE 3

Test condition: under normal temperature and normal pressure

Test materials: water absorbing article (paper towel) 20 g, water at 40° C. 80 g, one toilet-flushable type biodegradable collection bag with a size of 200 mm×270 mm×45 μm.

The above-mentioned water absorbing article (paper towel) 20 g was soaked homogeneously with 80 g water at 40° C. to produce a wet article having a water content of 80% and a total weight of 100 g. One toilet-flushable type biodegradable collection bag with a size of 200 mm×270 mm×45 μm was used to pack this wet article and then hung for observation.

Test result: In 5 seconds, wrinkles appeared on the surface of the bag contacting with the wet article, and the bag became soft but had no break; after 4 min, small crack appeared at the part of the bag contacting with the wet article; after 15 min, the crack expanded to 3 centimeters (cm) and tended to expand larger; after 30 min, the bag broke badly and the crack was larger than 5 cm; after 45 min, the bag broke completely and the article in the bag fell from the bag.

The monolayer bag with the same size prepared from the film in example 8 or 9 was also tested according to the water-resistance test described in example 1 and 2, and the result was same.

### APPLICATION EXAMPLE

The course of collecting pet waste using the collection bag in example 1-13 is shown in FIG. 3: stretch one hand into the collection bag 10 firstly; overturn the bag body after the pet waste was packed with the bag; then discard the bag directly into the toilet and flush it away with water. To be noticed, the opening of the bag should not be tied closely before discarded into the toilet because a substantial amount of air left in the bag influences the contact of the bag with water and then influences flushability of the bag by the toilet water flow.

In the above-mentioned example, the bag containing pet waste maintains excellent strength and water-resistance before discarded into the toilet. Once the bag is discarded into the toilet to contact with plenty of water, it can be seen that the bag body softens or disintegrates rapidly and then is flushed into the sewer.

Although certain apparatus constructed in accordance with the teachings of the invention have been described herein, the scope of coverage of this patent is not limited thereto. On the contrary, this patent covers every apparatus, method and article of manufacture fairly falling within the scope of the appended claims either literally or under the doctrine of equivalents.

What is claimed is:

1. A toilet-flushable type biodegradable collection bag, which is prepared from polyvinyl alcohol film and wherein at least the film of the bag body portion for contacting with the collection is a first film which has a thickness of approximately 15 to 100 μm and is manufactured by a film-composition comprising:
about 10 wt. %-90 wt. % of polyvinyl alcohol resin raw material,
about 0-20 wt. % of filling agent,
about 0-50 wt. % of natural polymer material, and
about 8 wt. %-50 wt. % of plasticizer;
wherein the polyvinyl alcohol resin raw material consists of a low alcoholysis degree polyvinyl alcohol resin having an alcoholysis degree of about 80 mol % to 93 mol % and a high alcoholysis degree polyvinyl alcohol resin having an alcoholysis degree of about 93.1 mol % to 99.99 mol %, and the ratio of the low alcoholysis degree polyvinyl alcohol resin to the high alcoholysis degree polyvinyl alcohol resin is from about 90:10 to 0:100 (w/w).

2. The toilet-flushable type biodegradable collection bag according to claim 1, wherein the polyvinyl alcohol resin raw material used for manufacturing the first film has a polymerization degree of from about 300 to 3500.

3. The toilet-flushable type biodegradable collection bag according to claim 2, wherein the polyvinyl alcohol resin raw material has a polymerization degree of from about 1000 to 2500.

4. The toilet-flushable type biodegradable collection bag according to claim 1, wherein the low alcoholysis degree polyvinyl alcohol resin has an alcoholysis degree of about 86 mol % to 93 mol %.

5. The toilet-flushable type biodegradable collection bag according to claim 1, wherein the ratio of the low alcoholysis degree polyvinyl alcohol resin to the high alcoholysis degree polyvinyl alcohol resin is from about 75:25 to 0:100 (w/w).

6. The toilet-flushable type biodegradable collection bag according to claim 1, wherein the filler is at least one selected from the group consisting of olefin, Polyethylene wax, silicon dioxide, talcum powder, calcium carbonate, magnesium carbonate, magnesium hydroxide, calcium stearate, titanium dioxide, lithopone, magnesium stearate, Octadecanamide and stearic acid; the natural polymer material is at least one selected from the group consisting of cellulose, xylogen, starch, chitin, chitosan and polysaccharide modifier; and the plasticizer is at least one selected from the group consisting of glycerol, digylcerol, polyethylene glycol, polypropylene glycol, caprolactam, trimethylolpropane, water and sorbitol.

7. The toilet-flushable type biodegradable collection bag according to claim 1, wherein the PVA resin raw material in the film-composition used for manufacturing the first film has a content of about 20 wt. %-80 wt. %.

8. The toilet-flushable type biodegradable collection bag according to claim 1, wherein the natural polymer material in the film-composition used for manufacturing the first film has a content of about 0-45 wt. %.

9. The toilet-flushable type biodegradable collection bag according to claim 1, wherein the filler in the film-composition used for manufacturing the first film has a content of about 2 wt. %-15 wt. %.

10. The toilet-flushable type biodegradable collection bag according to claim 1, wherein the plasticizer in the film-composition used for manufacturing the first film has a content of about 16 wt. %-40 wt. %.

11. The toilet-flushable type biodegradable collection bag according to claim 1, wherein the first film has a thickness of about 20 μm to 70 μm.

12. The toilet-flushable type biodegradable collection bag according to claim 1, wherein the bag body of the collection bag has a structure of a double layer film in which at least the layer used for contacting with the collection is the first film; or the bag body of the collection bag has a structure of monolayer film prepared from the first film.

13. The toilet-flushable type biodegradable collection bag according to claim 2, wherein the bag body of the collection bag has a structure of a double layer film in which at least the layer used for contacting with the collection is the first film; or the bag body of the collection bag has a structure of monolayer film prepared from the first film.

14. The toilet-flushable type biodegradable collection bag according to claim 4, wherein the bag body of the collection bag has a structure of a double layer film in which at least the layer used for contacting with the collection is the first film; or the bag body of the collection bag has a structure of monolayer film prepared from the first film.

15. The toilet-flushable type biodegradable collection bag according to claim 5, wherein the bag body of the collection bag has a structure of a double layer film in which at least the layer used for contacting with the collection is the first film; or the bag body of the collection bag has a structure of monolayer film prepared from the first film.

16. The toilet-flushable type biodegradable collection bag according to claim 7, wherein the bag body of the collection bag has a structure of a double layer film in which at least the layer used for contacting with the collection is the first film; or the bag body of the collection bag has a structure of monolayer film prepared from the first film.

17. The toilet-flushable type biodegradable collection bag according to claim 8, wherein the bag body of the collection bag has a structure of a double layer film in which at least the layer used for contacting with the collection is the first film; or the bag body of the collection bag has a structure of monolayer film prepared from the first film.

18. The toilet-flushable type biodegradable collection bag according to claim 9, wherein the bag body of the collection bag has a structure of a double layer film in which at least the layer used for contacting with the collection is the first film; or the bag body of the collection bag has a structure of monolayer film prepared from the first film.

19. The toilet-flushable type biodegradable collection bag according to claim 10, wherein the bag body of the collection bag has a structure of a double layer film in which at least the layer used for contacting with the collection is the first film; or the bag body of the collection bag has a structure of monolayer film prepared from the first film.

20. The toilet-flushable type biodegradable collection bag according to claim 1, wherein the collection is one or more of pet waste, excrement, or vomit.
